(19) United States
(12) Patent Application Publication
(10) Pub. No.: US 2006/0093841 A1
(43) Pub. Date: May 4, 2006

(54) Method of forming ferroelectric thin film

(75) Inventors: Ju-chul Park, Gyeonggi-do (KR); Si-kyung Choi, Daejeon-si (KR); Won-woong Jung, Seoul (KR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Samsung Electronics Co., Ltd., Gyeonggi-do (KR)

(21) Appl. No.: 11/175,173

(22) Filed: Jul. 7, 2005

(30) Foreign Application Priority Data
Nov. 3, 2004 (KR) 10-2004-0088859

(51) Int. Cl. B32B 15/04; B32B 9/00; B32B 19/00

(52) U.S. Cl. 428/472; 428/701; 428/702; 427/372.2

(57) ABSTRACT

A method of forming a ferroelectric thin film for suppressing the formation of a-domain and providing a sufficient layer coverage may be provided. The method includes immersing a substrate having the miscut surface into a reaction solution including a precursor compound for perovskite-type ferroelectric and water, and implementing a hydrothermal reaction in the reaction solution at a temperature lower than the phase transition temperature of the perovskite-type ferroelectric, thereby forming a perovskite-type ferroelectric thin film on the miscut surface of the substrate.

### BACKGROUND OF THE DISCLOSURE

This application claims the priority of Korean Patent Application No. 10-2004-0088859, filed on Nov. 3, 2004, in the Korean Intellectual Property Office, the disclosure of which is incorporated herein in its entirety by reference.

1. Field of the Disclosure

The disclosure relates to a method of forming a ferroelectric thin film, and particularly, to a method of forming a perovskite-type ferroelectric thin film.

2. Description of the Related Art

Ferroelectrics mean a material having spontaneous polarization characteristics. In specific, after causing polarization in a ferroelectric material by an electric field, and then, even after removing the electric field, the ferroelectric material maintains the polarization state. As main examples of the ferroelectric having such a property, there are perovskite-type compounds, such as SrBi₂Ta₂O₉(SBT) series, Pb(Zr, Ti)O₃(PZT) series, or the like. Further, it is known that ferroelectric has a high dielectric constant.

Accordingly, ferroelectric may be utilized in various devices requiring a high dielectric constant and/or spontaneous polarization. For example, ferroelectric can be usefully employed in a capacitor, a piezoelectricity, a pyroelectricity, an electric optical device, a memory device, a sensor, an actuator and the like.

In such devices, the ferroelectric is normally used as a thin film. A representative example of a memory device using the ferroelectric may be a ferroelectric random access memory (FeRAM). The FeRAM is mainly classified into 1T/1C (one transistor/one capacitor) type and FET type. In the capacitor, the ferroelectric is used as a dielectric thereof. In the FET type FeRAM, the ferroelectric is used as a gate insulator. Further, the ferroelectric, which is used as a gate insulator in the FET type FeRAM, also functions to maintain charges on the surface of a semiconductor substrate by spontaneous polarization. The FeRAM shows nonvolatile property by the spontaneous polarization of the ferroelectric. In this case, it should be noted that the capacitor insulating layer or the gate insulating layer of the FeRAM is formed as the shape of a thin film.

A conventional method of forming a dielectric thin film is roughly classified into a dry method and a wet method. The dry method includes a vacuum deposition, a sputtering, a CVD and the like. The wet method includes chemical etching, thermal bunching, hydrothermal reaction, zol-gel method, spray coating and the like.

The dry method has disadvantages. Annealing treatment is performed at a high temperature for crystallization during the formation of a layer. As a result, damage of the layer is unavoidable ([L. D. Madsen and E. M. Griwold, “Domain structures in Pb(Zr, Ti)O₃ and PbTiO₃ thin films”, J. Mater. R, 12(10), 2612 (1997)]. Further, the selection of a substrate to be used is limited, and separation and crack of the layer during heating may occur [M. Yoshimura, S. E. Yoo, M. Hayashi and N. Ishizawa, “Preparation of BaTiO₃ Thin Film by Hydrothermal electrochemical method”, Jpn. J. Appl. Phys., 28(11), L2007(1989)].

Further, the ferroelectric may lose its ferroelectricity above a temperature of Tc (phase transition temperature, or Curie temperature) and exhibits paraelectricity. On the contrary, when the ferroelectric having a temperature above Tc is cooled, it may lose its paraelectricity and again exhibit ferroelectricity. As such, the change from the paraelectricity to the ferroelectricity is called phase transition.

A method of forming a thin film composed of a ferroelectric material on a substrate at a temperature above the Curie temperature Tc involves cooling the thin film to a temperature below the temperature Tc to make the thin film exhibit ferroelectricity. The ferroelectric thin film formed by the method and through the phase transition process comes to have an a-domain and a c-domain existing therein together. In the a-domain, ferroelectric crystal lattices are aligned along an a-axis. In the c-domain, ferroelectric crystal lattices are aligned along a c-axis. The a-domain is advantageous to realize a high dielectric constant, and the c-domain is advantageous to form spontaneous polarization. On account of this, in the device to require just a high dielectric constant of ferroelectric, or the device to require only spontaneous polarization of ferroelectric, the coexistence of the a-domain and c-domain may not be desirable (Ferroelectric Materials and Their Applications, Yuhuan Xu, 1991).

Further, in the ferroelectric thin film formed by the phase transition process, the holes formed inside the thin film due to poor layer coverage may cause an electric short phenomenon in upper and lower electrodes, and the analysis for electrical characteristics may be impossible.

In the meantime, the wet-type hydrothermal reaction method is advantageous in that the various factors in the reaction is possible to control, such as reaction temperature, reaction pressure, concentration of solute, concentration of solvent, concentration of additives, thermal mechanical variables, and amount ratios of components. Also, a calcination or sintering process is not necessary, and the generation of the a-domain is suppressed at a relatively low temperature, thereby to provide a film having good residual polarization characteristics and improved in its crystal structure.

As another wet-type method, the zol-gel method involves coating a solution having multicomponents with selective component ratios on a substrate and drying to provide a film having desired composition and characteristics through a reaction process. The method has advantages that components are easy to control and reaction is occurred at a low temperature to provide uniform structural state of the resultant film, and furthermore, the costs of the formation process is low and the formation process to be employed in various application fields is easy to perform.

As such, among the wet-type methods, the hydrothermal reaction process and the zol-gel method have many advantages, but the methods also have problems. Specifically, the hydrothermal reaction method imparts a rough surface on the film even though providing excellent formation and growth of crystal nuclei, and the zol-gel method imparts cracking and peeling-off phenomenon of the resultant film.

### SUMMARY OF THE DISCLOSURE

The present invention may provide a method of forming a ferroelectric thin film for suppressing the formation of a-domain and providing a sufficient layer coverage.

The present invention may provide a substrate having the ferroelectric thin film.

According to an aspect of the present invention, there is provided a method of forming a ferroelectric thin film including forming a perovskite-type ferroelectric on the miscut surface of a substrate using a hydrothermal reaction process.

The hydrothermal reaction process may be performed by immersing the substrate having the miscut surface into a reaction solution including a precursor compound for the perovskite-type ferroelectric and water, and implementing a thermal reaction at a temperature lower than the phase transition temperature of the perovskite-type ferroelectric.

The reaction solution may further include a mineralizer.

According to another aspect of the present invention, there may be provided a substrate having a miscut surface and a perovskite-type ferroelectric thin film formed on the miscut surface.

In the method of the present invention, as the perovskite-type ferroelectric thin film is formed on the miscut surface, the formation of the ferroelectric thin film may involve a layer by layer growth. Thus, the layer coverage of the ferroelectric thin film formed thereby may be significantly improved.

Further, in the method of the present invention, as the perovskite-type ferroelectric thin film is formed by a hydrothermal reaction method, the temperature of the perovskite-type ferroelectric thin film formed may not be increased above its phase transition temperature. Therefore, as the perovskite-type ferroelectric thin film formed by the present invention does not pass through a phase transition, the formation of an a-domain may not occur, or the formation of the a-domain is effectively suppressed.

Further, in the method of the present invention, as the perovskite-type ferroelectric thin film is formed through a heteroepitaxial growth, crystals may be aligned in a single direction so as to provide such a ferroelectric film.

Further, in the method of the present invention, as the perovskite-type ferroelectric thin film is formed at a low temperature below the phase transition temperature, a thermal stress applied to the formed ferroelectric thin film may be minimized, and the formation of oxygen vacancy may be minimized. Furthermore, in the case that a material having a high volatility such as lead is involved, it may prevent the material from easily volatilization.

### BRIEF DESCRIPTION OF THE DRAWINGS

The above and other features and advantages of the present invention will become more apparent by describing in detail exemplary embodiments thereof with reference to the attached drawings in which:

FIG. 1 is a view illustrating a perovskite-type crystal structure at a temperature above Tc;

FIG. 2 is a view illustrating a perovskite-type crystal structure at a temperature below Tc;

FIG. 3 is a view illustrating the miscut surface of a substrate as ideal;

FIG. 4 is a view illustrating an XRD analysis result of the PbTiO₃ thin film formed according to an embodiment of the present invention;

FIG. 5 is a high resolution transmission electron microscopes (HRTEM) image of the PbTiO₃ thin film formed according to an embodiment of the present invention;

FIG. 6A is a high magnification (500 times) scanning electron microscopy (SEM) image of the PbTiO₃ thin film formed according to an embodiment of the present invention;

FIG. 6B is a low magnification (50 times) SEM image of the PbTiO₃ thin film formed according to an embodiment of the present invention; and

FIG. 7 is an SEM image of the PbTiO₃ thin film formed by a comparative example.

### DETAILED DESCRIPTION OF THE EXEMPLARY EMBODIMENT

The present invention will now be described more fully hereinafter with reference to the accompanying drawings, in which exemplary embodiments of the invention are shown. This invention may, however, be embodied in many different forms and should not be construed as being limited to the embodiments set forth herein. Like numbers refer to like elements throughout the specification.

A method of forming a ferroelectric thin film according to the present invention may include immersing a substrate having a miscut surface into a reaction solution including a precursor compound for a perovskite-type ferroelectric and water, and implementing a hydro-thermal reaction process at a temperature lower than the phase transition temperature of the perovskite-type ferroelectric, so as to form a perovskite-type ferroelectric film on the miscut surface of the substrate.

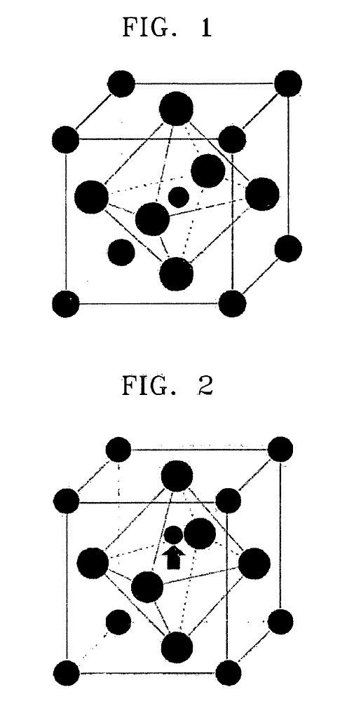

In the present invention, the perovskite-type ferroelectric means a material having a perovskite-type crystal structure. The perovskite-type crystal structure may be referred to as “ABO₃”. FIG. 1 illustrates a perovskite-type crystal structure at a temperature above Tc. As shown in FIG. 1, ⅛ of one negative ion “A” is disposed at each of eight corners, another negative ion “B” is disposed at a body center, and ½ of one positive ion is disposed at each of six face centers, i.e., three positive ions “O₃”. As such, one metal ion at the position “B” and oxygen ions surrounding the metal ion form a regular octahedron, and these octahedrons are aligned to provide a cubic structure.

However, as shown in FIG. 2, the “B” ion is deviated from the center of the crystal, and moved upward or downward at a temperature below Tc. Accordingly, polarization is generated. In the polarization state, the perovskite-type crystal structure comes to have a tetragonal or rhombohedral shape. In the state, the polarization vector is formed in the direction of a c-axis.

The “A” may be, for example, Ba, Pb, K, Na or the like. The “B” may be, for example, Ti, Zr, Nb, Ta or the like.

As specific examples of the perovskite-type ferroelectric, there are BaTiO₃, PbTiO₃, Pb(Zr, Ti)O₃, (Pb, La)(Zr, Ti)O₃, KNbO₃ or the like.

In the present invention, a “precursor compound for perovskite-type ferroelectric” means a compound or compounds which may be transformed to a perovskite-type ferroelectric compound through a hydrothermal reaction process.

For example, in the case of achieving a PbTiO₃ thin film, a mixture of a Pb-containing compound and a Ti-containing compound may be used as the “precursor compound for perovskite-type ferroelectric”. As examples of the Pb-containing compound, there are Pb(NO₃)₂, Pb(CH₃COO)₂, Pb(OH)₂, PbO, or the like. As examples of the Ti-containing compound, there are TiO₂, Ti[O(CH₂)₃CH₃]₄ or the like.

For another example, a mixture of a Ba-containing compound and a Ti-containing compound may be used for the “precursor compound for perovskite-type ferroelectric” to achieve a BaTiO₃ thin film. The Ba-containing compound may use Ba(NO₃)₂, BaO, Ba(OH)₂ or the like. The Ti-containing compound may use TiO₂, Ti[O(CH₂)₃CH₃]₄ or the like.

For still another example to achieve a Pb(Zr, Ti)O₃ thin film, a mixture of a Pb-containing compound, a Zr-containing compound, and a Ti-containing compound may be used for the “precursor compound for perovskite-type ferroelectric”. As examples of the Pb-containing compound, there are Pb(NO₃)₂, Pb(CH₃COO)₂, Pb(OH)₂, PbO or the like. As examples of the Zr-containing compound, there are ZrO₂, ZrOCl₂ or the like. As examples of the Ti-containing compound, there are TiO₂, Ti[O(CH₂)₃CH₃]₄ or the like.

In addition to these compounds, various compounds or a compound may be used for the “precursor compound for perovskite-type ferroelectric”, and the compound may be appropriately selected in accordance with components of the ferroelectric to be achieved.

In the present invention, the reaction solution may include a precursor compound for perovskite-type ferroelectric and water. The reaction solution may have a form of solution, emulsion or suspension. Here, the water acts as a reaction medium for the hydrothermal reaction and/or a source of oxygen.

The component ratio of the reaction solution is not specifically limited. However, if the ratio of water in the solution is too low, the mixing state of the reaction solution is not uniform because of a poor solubility. On the contrary, if the ratio of water is too high, ions cannot be adsorbed on the substrate because of a low ion density. In consideration of this, the precursor compound for perovskite-type ferroelectric in the reaction solution may be contained with a density in the range of about 0.2 to about 0.5 M.

In the present invention, the substrate may have a miscut or stepped surface. The substrate is not limited to a specific material to be used. For example, the substrate may use a material such as Nb—SrTiO₃, Si, LaAlO₃, SrTiO₃, MgO, Ti/Si or the like. Specifically, the material of the substrate may be Nb—SrTiO₃ or Ti/Si when the substrate is employed in the fabrication of memory devices or formation processes of capacitors.

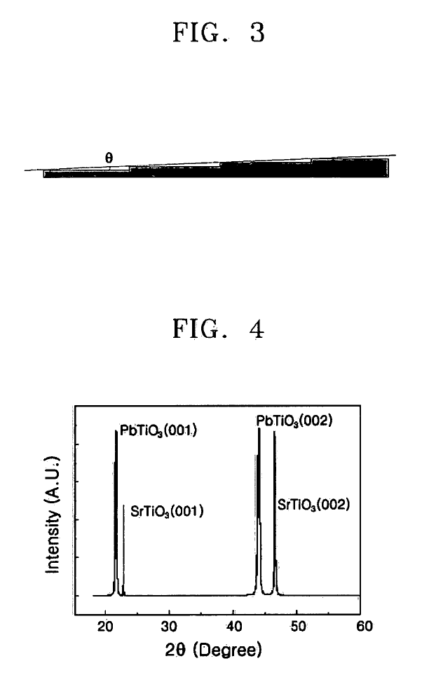

The miscut surface means a stepped surface. As shown in FIG. 3, the angle θ of the miscut surface is defined as “tan θ=(height of a step)/(width of a step)”.

From the miscut angle, the height of the step must be close to the value of a lattice constant c of unit pixel of the ferroelectric thin film. Particularly, in the formation of a hetroepitaxial thin film, if a material having a lattice constant higher or lower than that of the substrate is used for epitaxial deposition of the thin film, there may exist a coherent elastic strain in the thin film because of the difference of the lattice constants of two materials, thereby to cause roughness on the surface of the thin film.

For example, if the lattice constant c of unit cell of the ferroelectric material is 0.4 nm, the substrate must be miscut at an angle of 0.2° such that the height of a step is about 0.4 nm. In consideration of this, the miscut angle of the surface is preferably about 0.2° to about 0.5°, and more preferably, about 0.3° to about 0.4°. However, the dimensions of the height and width of a step in the miscut surface are not necessary to limit to specific ones.

In the present invention, the hydrothermal reaction of the reaction solution may be performed using, for example, an autoclave. That is, the reaction solution and the substrate may be put into an autoclave, to perform the hydrothermal reaction process of the reaction solution, so that a ferroelectric thin film may be formed on the miscut surface of the substrate.

The hydrothermal reaction process of the reaction solution may be performed at a temperature lower than the phase transition temperature of the perovskite-type ferroelectric to be achieved. Further, a hydrothermal reaction temperature of the reaction solution is desirably considered for the formation of high pressure and the ionization of the precursor compound. If the hydrothermal reaction temperature of the reaction solution is too low, the precursor compounds cannot be ionized sufficiently, and as the pressure is not sufficiently high, an epitaxial thin film cannot be formed. On the contrary, if the temperature is too high, the pressure inside the autoclave is increased so as to apply a stress to the thin film. In consideration of this, the hydrothermal reaction temperature of the reaction solution is normally in the range of about 150 to about 250° C., and preferably, about 180 to about 190° C.

The pressure for the hydrothermal reaction of the reaction solution is not limited specifically. However, if the hydrothermal reaction pressure of the reaction solution is too low, good crystalline quality of the thin film cannot be achieved, and the ferroelectric phase may not be formed. On the contrary, if the pressure is too high, a stress may be applied on the thin film. In consideration this, the hydrothermal reaction pressure of the reaction solution is normally about 5 to about 15 MPa, and preferably, about 9 to about 13 MPa.

The time of the hydrothermal reaction of the reaction solution is not limited specifically, and can be appropriately selected in accordance with the thickness of the ferroelectric thin film to be achieved.

During the hydrothermal reaction process, the reaction solution may further include a mineralizer in order to activate the reaction of the ferroelectric. Using the mineralizer, a required time for the hydrothermal reaction can be shortened. As the mineralizer, there are KOH, NaOH, LiOH, RbOH, NH₄OH or mixtures thereof. If the amount of the mineralizer to be added is too small, as the effect of the mineralizer may be so insignificant, and the ionization of the precursor compound cannot be processed sufficiently, a desired thin film is not formed. On the contrary, if the amount of the mineralizer added is too much, as the ionization may be processed so rapidly, a polycrystalline thin film may be formed. In consideration of this, the density of the mineralizer in the reaction solution is normally in the range of about 4 to about 10 M, and preferably, about 7 to about 8 M.

Hereinafter, the present invention will be described in more detail with reference to an exemplary embodiment. The following example is for illustrative purposes and is not intended to limit the scope of the invention.

### EXAMPLE

The substrate used in this example was composed of Nb—SrTiO₃(001). The substrate had a miscut surface having an angle of 0.2°. The dimension of the substrate was 1 cm×1 cm×0.05 cm. A reaction solution for a hydrothermal reaction method was prepared by mixing 1 g of Pb(NO₃)₂, 0.2 g of TiO₂ powder, and 20 ml of 8M KOH solution. The reaction solution and the Nb—SrTiO₃ substrate were put into a high pressure reactor. The Nb—SrTiO₃ substrate came to be immersed into the reaction solution inside the reactor. Then, a hydrothermal reaction process was performed on the reaction solution for 16 hours under the conditions of 200° C. of temperature and 15 MPa of pressure. By the process, a PbTiO₃ thin film is formed on the miscut surface of the Nb—SrTiO₃ substrate.

An XRD analysis result of the PbTiO₃ thin film formed as above is shown in FIG. 4. In the XRD patterns of FIG. 4, a PbTiO₃(001) peak and a PbTiO₃(002) peak are shown high, while an SrTiO₃(001) peak and an SrTiO₃(002) peak are shown low. The SrTiO₃ peak is caused by the substrate. From the result, it is acknowledged that the component material of the thin film formed by this exemplary embodiment is PbTiO₃(001) (and a ferroelectric PTO thin film of a perovskite-type structure).

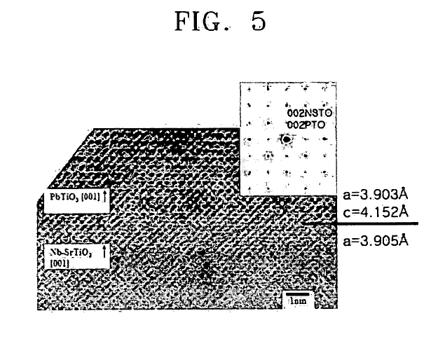

FIG. 5 is a high resolution transmission electron microscopes (HRTEM) image of the PbTiO₃ thin film formed by this embodiment of the present invention. As shown in FIG. 5, the PbTiO₃ thin film formed by the example had no a-domain.

Normally, if an a-domain exists in the thin film, diffraction spots are shown in the diffraction pattern by twin crystal, but it is acknowledged that there were not generated diffraction spots in the diffraction pattern of FIG. 5 by twin crystal.

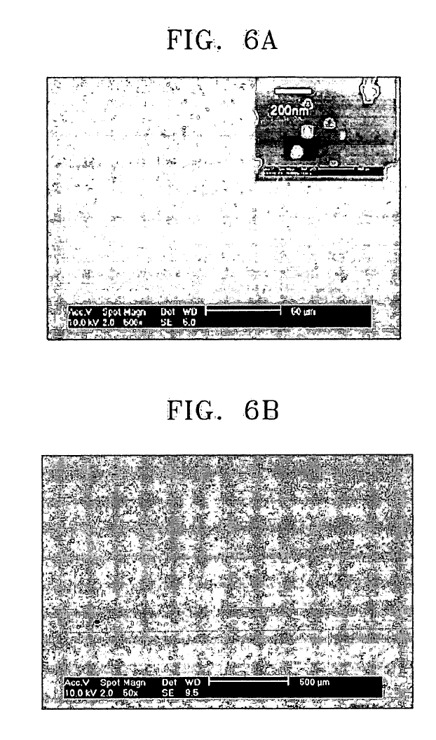

FIGS. 6A and 6B illustrate an SEM image of the PbTiO₃ thin film formed by this embodiment of the present invention. In particular, from the view of the low magnification SEM image of the thin film surface (see FIG. 6B), it is acknowledged that the PbTiO₃ thin film formed by this embodiment has good layer coverage characteristics.

### COMPARATIVE EXAMPLE

The comparative example was performed by the same processes as the above example of the present invention except the use of the miscut-surfaced substrate to form a PbTiO₃ thin film.

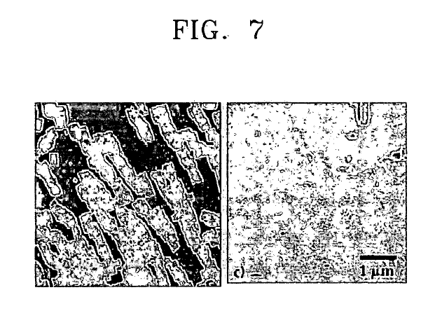

The SEM image of the PbTiO₃ thin film achieved from the comparative example is shown in FIG. 7. As shown in FIG. 7, the layer coverage of the PbTiO₃ thin film formed by the comparative example is very poor and further, it is found from FIG. 7 that many holes exist on the thin film due to an island growth, because the used substrate has no stepped surface.

According to the present invention, a perovskite-type ferroelectric film is formed on the miscut surface of a substrate, and a layer by layer growth is also involved in the formation of the ferroelectric film so that a layer coverage is very excellent, and the generation of an a-domain is suppressed by a hydrothermal reaction method to form a ferroelectric thin film.

The ferroelectric thin film formed according to the present invention can be used in a capacitor, a piezoelectricity, a pyroelectricity, an electric optical device, a memory device, a sensor, an actuator and the like.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of forming a ferroelectric thin film comprising forming a perovskite-type ferroelectric on the miscut surface of a substrate using a hydrothermal reaction process.

2. The method of claim 1, wherein the hydrothermal reaction process is performed by immersing the substrate having the miscut surface into a reaction solution comprising a precursor compound for the perovskite-type ferroelectric and water, and implementing a thermal reaction at a temperature lower than the phase transition temperature of the perovskite-type ferroelectric.

3. The method of claim 2, wherein the reaction solution further comprises a mineralizer.

4. A substrate comprising a miscut surface; and a perovskite-type ferroelectric thin film formed on the miscut surface.
